(19) United States
(12) Patent Application Publication
(10) Pub. No.: US 2005/0204345 A1
(43) Pub. Date: Sep. 15, 2005

(54) Method and apparatus for monitoring computer software

(76) Inventors: Jose German Rivera, Sunnyvale, CA (US); Lillian Chou, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/786,843

(22) Filed: Feb. 25, 2004

(51) Int. Cl. G06F 9/44; G06F 13/24

(52) U.S. Cl. 717/127

(57) ABSTRACT

Computer software is monitored by receiving an assertion from an executing process, recording the assertion when it is violated and allowing the executing process to continue execution.

### BACKGROUND

A computer program, also called software, is a sequence of instructions that a computer carries out in order to perform some desired function. The terms “program”, “program code”, “code” and “software” often are used interchangeably and in a wide variety of combinations to refer to instructions and instruction sequences.

A source line of code is generally considered to be a high-level statement made by a computer programmer. Commercial software programs are complex creations, often embodied in hundreds of thousands of these source lines of code. In a development environment, complex software programs are typically subdivided into simpler, smaller components or modules that work together to create the entire program.

Computer programmers use various types of programming languages to create the high-level source lines of code. Modernly, computer programmers work within a programming environment. A programming environment is a suite of tools that collectively provide various facilities for creating, analyzing and debugging a software program.

An assertion tool is one of many tools used by programmers as they develop computer programs. The assertion tool does not directly add useful functionality to a program from an end user's perspective. Rather, the assertion tool allows computer programmers to validate certain aspects of a computer program as it executes.

It is useful to think of the assertion tool as a specialized computer instruction that causes the computer program to record information that pertains to an error or other extraordinary event as the computer program executes. Once the information is recorded, the assertion tool causes the executing computer program to terminate so that the computer programmer can evaluate the error or extraordinary event. In many programming languages and programming environments, the assertion instruction is coded at a high level with the statement “assert( )”. A logical or mathematical expression is typically included in an assertion statement, e.g. “assert(expression)”. As a computer program executes, the computer evaluates the expression to determine whether it is TRUE or FALSE. If the assertion's expression comes up FALSE, the assertion is said to be “violated”. In this case, the computer program is terminated and information pertaining to the assertion is recorded for further analysis by the computer programmer.

A typical use of an assert( ) statement in a programming module is to test that input data to the module is within an expected range or meets certain conditions. For example, if a module expects to receive input data representing the number of employees in a payroll cycle, a computer programmer might use an assertion statement to ensure that the data is reasonable. This is especially true when the computer programmer is not confident that the source of the input data will provide such reasonable data. For example, if the data representing the number of employees in a payroll cycle is coming from another module that is used, for example, to track employee attendance, there is a possibility that the source module will provide data that is outside the expected range of input values. For example, a negative number is simply not an expected value for the number of employees in a payroll cycle. Accordingly, a computer programmer may introduce an assertion that includes an expression such as “Number_of_Employees>=ZERO”. If the input data from the attendance module were to be a negative number (which would not make sense to the module receiving such data), the computer would evaluate the expression as FALSE. In the common terminology, we say that the assertion has failed or that the assertion has been violated. Typically, when an assertion is violated the computer system prints out a message and aborts program execution. If, instead, the input data were zero or a positive number, the computer would evaluate the expression as TRUE. Typically, if the expression is evaluated as TRUE, program execution is allowed to continue with the next instruction.

Most programming environments used by computer programmers have a simple way to enable (turn on) and to disable (turn off) all assertions in a program. When assertions are disabled, the programming environment simply ignores assertion statements and does not include them in the resulting software. Generally, computer programmers enable assertions during debugging and testing activities as they develop a computer program. By using assertions during development, computer programmers can quickly discover and remedy design flaws (i.e. “bugs”) in their high-level source lines of code.

Each time the expression associated with an assertion is evaluated, additional processing resources are consumed. Once the computer program has been “debugged”, the assertions typically serve no useful purpose. This is why a programming environment allows a computer programmer to disable assertions. The terms “release code” and “production code” refer to a computer program (i.e. software) that is to be released (e.g. to customers). Release code is typically devoid of assertions because the assertions cause performance degradation. Also, if an assertion were to fail during execution, the computer program would be aborted. Aborting program execution when an assertion is violated is not acceptable for release code. Consider the situation where an assertion that is included in an operating system (e.g. Microsoft Windows™), or other “continuously-running” software is violated. Aborting such continuously running software results in a system crash, which is an unacceptable artifact of a violated assertion.

Assertions can be seen as a built-in mechanism for detecting unexpected behavior in a computer program. Even release code can exhibit unexpected behavior. Because assertions are not included in the release version of the software, computer programmers are deprived of important information that can lead to identification of design flaws; especially those that may only become manifest through real customer usage. In many cases, such design flaws cannot be isolated in the development environment because the real customer usage of the software cannot be duplicated.

### SUMMARY

Presently disclosed are a method and apparatus, software and a computer readable medium that embody the method for monitoring computer software comprising receiving an assertion from an executing process, recording the assertion when it is violated and allowing the executing process to continue execution.

### BRIEF DESCRIPTION OF THE DRAWINGS

The present disclosure will hereinafter be described in conjunction with the appended drawings and figures, wherein like numerals denote like elements, and in which:

FIG. 1 is a flow diagram that depicts one example embodiment of a method for monitoring computer software;

FIG. 2 is a flow diagram that depicts one alternative embodiment of a method for receiving an assertion from an executing process;

FIG. 3 is a pictorial representation of one example embodiment of a table used to control assertion acceptance;

FIG. 4 is a flow diagram that depicts an illustrative embodiment of a method for recording an assertion;

FIG. 5 is a flow diagram that depicts two illustrative example embodiments of methods for recording an assertion;

FIG. 6 is a flow diagram that depicts an example embodiment of a method for specifying enablement of assertions;

FIG. 7 is a flow diagram that depicts one illustrative alternative example embodiment of a method for generating an error report;

FIG. 8 is a block diagram that depicts one illustrative embodiment of a software monitor;

FIG. 9 is a block diagram that depicts one illustrative alternative embodiment of an assertion receiver;

FIG. 10 is a block diagram that depicts one illustrative alternative embodiment of an assertion recorder;

FIG. 11 is a block diagram that depicts one illustrative embodiment of an error report generator;

FIG. 12 is a block diagram that depicts one alternative example embodiment of a software monitor; and

FIGS. 13 and 14 collectively comprise a data flow diagram that depicts the operation of one illustrative embodiment of a software monitor.

### DETAILED DESCRIPTION

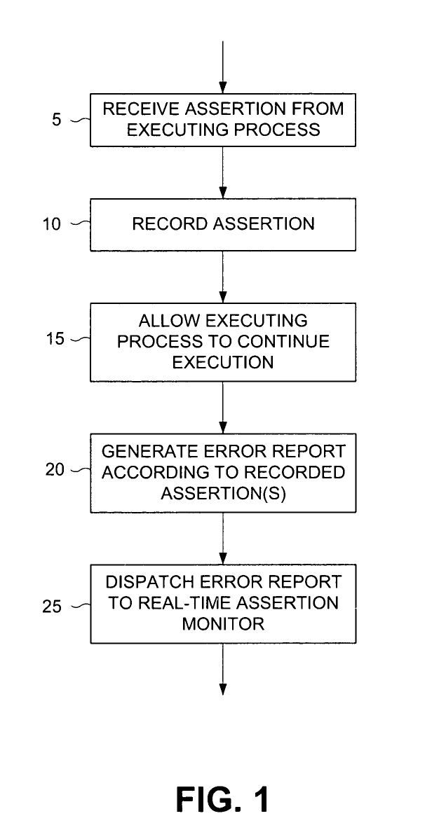

FIG. 1 is a flow diagram that depicts one example embodiment of a method for monitoring computer software. According to this example method, monitoring software comprises receiving an assertion from an executing process (step 5), recording the assertion (step 10) and allowing the executing process that sourced the assertion to continue executing (step 15). By allowing the executing process to continue, the executing process does not abort. Accordingly, where a process is, for example, integral to an operating system, the operating system will not “crash the system”. Likewise, where a process is integral to a user application, a user will not be frustrated as the application is commonly used. The present method is applicable to many various types of software and the scope of the appended claims is not intended to be limited to examples herein cited; e.g. such as an operating system or a user application.

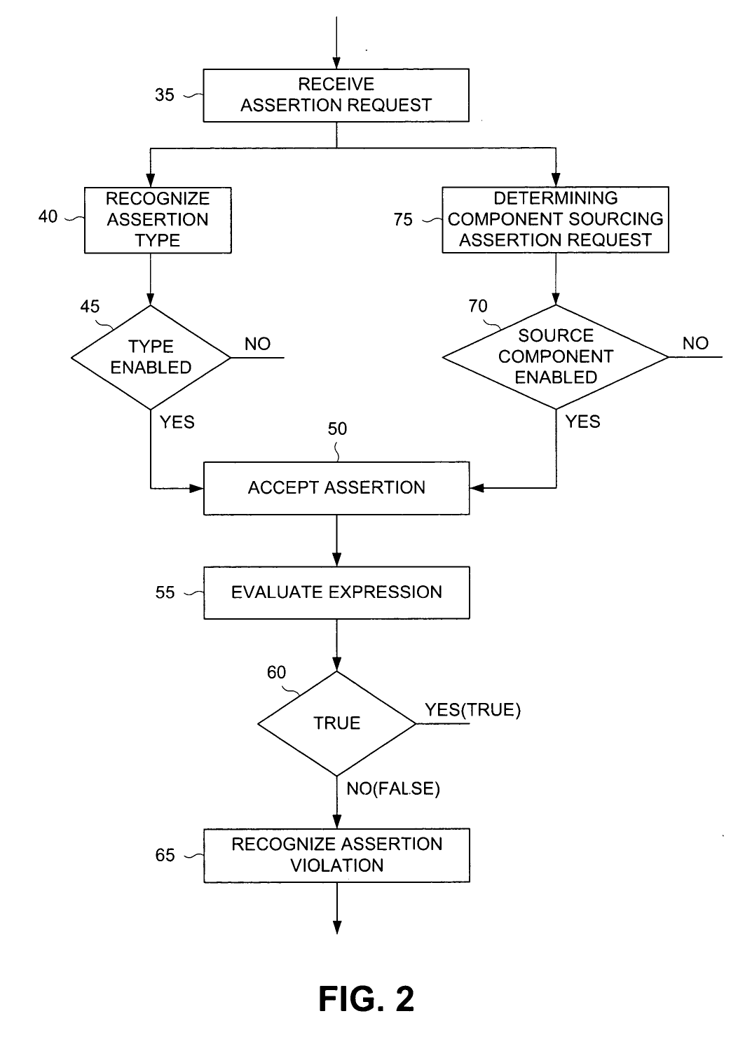

FIG. 2 is a flow diagram that depicts one alternative embodiment of a method for receiving an assertion from an executing process. For the purposes of this disclosure, an assertion is defined to be an indicator that an assertion request (e.g. an assertion call) received from an executing process was accepted. According to this alternative method, an assertion request, comprising an assertion type and an assertion expression, is received (step 35). The type of assertion requested is recognized (step 40). The assertion request is accepted (step 50) when the recognized type is enabled (step 45). When the recognized type is a type that is not enabled, the request is not accepted and the assertion request is merely ignored. Hence, the executing process that sourced the assertion request is allowed to continue executing because the assertion failed to materialize. When the assertion request is accepted (step 50), the expression associated therewith is evaluated (step 55). When the expression evaluates to TRUE (step 60), the assertion is completed. Hence, the executing process that sourced the assertion request is allowed to continue executing because the assertion was not violated. When the expression evaluates to FALSE (step 60), the receiver recognizes an assertion violation event (step 65). Accordingly, the example method depicted in FIG. 1 would proceed to record the assertion violation and allow the process to continue execution. Because different assertion types generally require different amounts of processor resources, the ability to enable only specific types of assertions allows a programmer to better manage the trade-off between the usefulness of a particular type of assertion and its associated cost (in required processor resources). In one example variation of this method, the received request takes the form of one of a group of defined assertion macro names that represent different assertion types.

FIG. 2 also depicts another alternative embodiment of a method for receiving an assertion. According to this variation of the present method, an assertion request is received (step 35). The component that sourced the assertion request is determined (step 75). The assertion request is accepted (step 50) when the determined assertion-sourcing component has assertions enabled (step 70). When the determined component does not have assertions enabled (step 70), the request is not accepted and the assertion request is merely ignored. Hence, the executing process that sourced the assertion request is allowed to continue executing because the assertion failed to materialize. When the assertion request is accepted (step 50), the expression associated therewith is evaluated (step 55). When the expression evaluates to TRUE (step 60), the assertion is completed. Hence, the executing process that sourced the assertion request is allowed to continue executing because the assertion was not violated. When the expression evaluates to FALSE (step 60), the receiver recognizes an assertion violation event (step 65). Accordingly, the example method depicted in FIG. 1 would proceed to record the assertion violation and allow the assertion-sourcing process to continue execution.

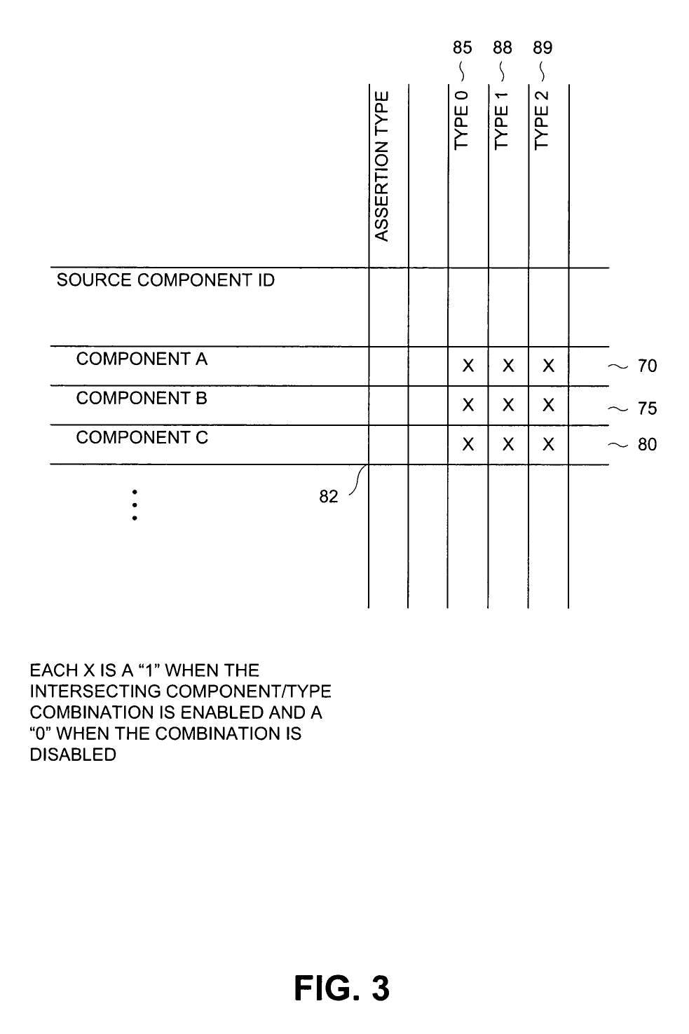

FIG. 3 is a pictorial representation of one example embodiment of a table used to control assertion acceptance. According to one alternative method for receiving an assertion, a program component specifies which types of assertions to enable, and this specification of each assertion type is independently made for each program component of a program. According to one alternative method for recognizing an assertion, the type of assertion is determined. The assertion request is accepted when the recognized type is enabled. According to yet another alternative method, the software component that sourced the assertion is determined and the assertion is accepted when the sourcing component has assertions enabled. Accordingly, the various methods described above may use a table 82 for storing information pertaining to enablement for assertion types. For example, the table 82 depicted in FIG. 3 enumerates three assertion types, Type 0 (85), Type 1 (88) and Type 2 (89). This illustrative example of a table 82 further enumerates three components, Component A (70), Component B (75) and Component C (80). This illustrative example of a table 82 enumerates assertion types along one axis and sourcing components along an axis orthogonal thereto. Enablement of a particular type of assertion for a particular sourcing component is specified by placing a flag at the intersection of the rows and columns of the table 82. It should be noted that the components and assertion types as well as their enablement state appearing in the figure are presented for illustration purposes only and are not intended to limit the scope of the claims appended hereto.

Given the table 82, when a method that accepts an assertion of a particular type needs to determine if an assertion type is enabled, the table 82 is consulted to determine if the assertion type is enabled for all sourcing components. When a method that accepts an assertion sourced by a particular component needs to determine if the sourcing component has assertions enabled, the table 82 is consulted to determine if all assertion types are enabled for the particular component that sourced the assertion. Given the information in the table 82, a flag placed at the intersection of an assertion type and a sourcing component indicates that the assertion type is enabled for that particular sourcing component. Accordingly, yet another variation of the present method is contemplated wherein acceptance of an assertion is qualified according to assertion type and sourcing component, simultaneously.

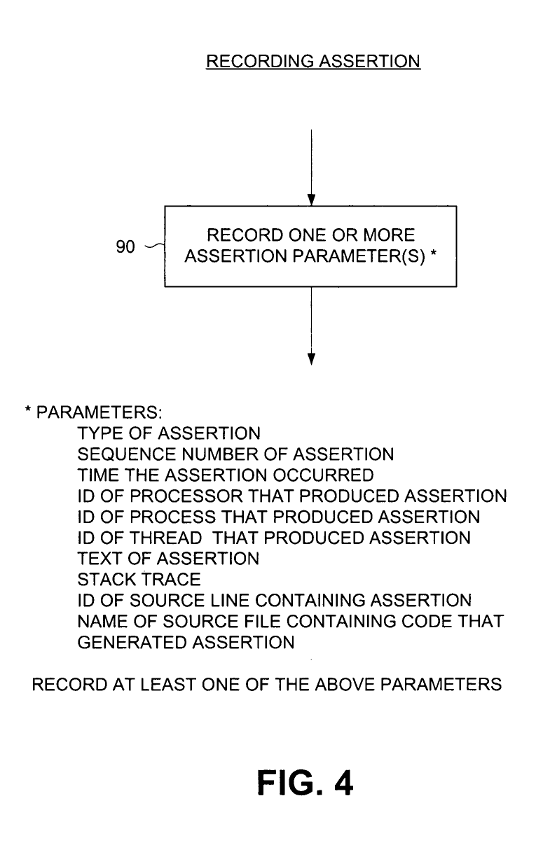

FIG. 4 is a flow diagram that depicts an illustrative method for recording an assertion. According to this illustrative variation of the present method, at least one assertion violation datum is recorded. An assertion violation datum includes, but is not limited to at least one of an assertion type, a sequence number, a time at which the assertion occurred, identification (ID) of a processor that produced the assertion, identification of a process that produced the assertion, identification of a thread that produced the assertion, text associated with the assertion, a stack trace, a source line containing the assertion and a file name of the source containing the code that generated the assertion (step 90). This assertion violation data, usually, but not necessarily after some formatting operation for readability, can be used by a programmer to help discover and remedy design flaws in high-level source lines of code.

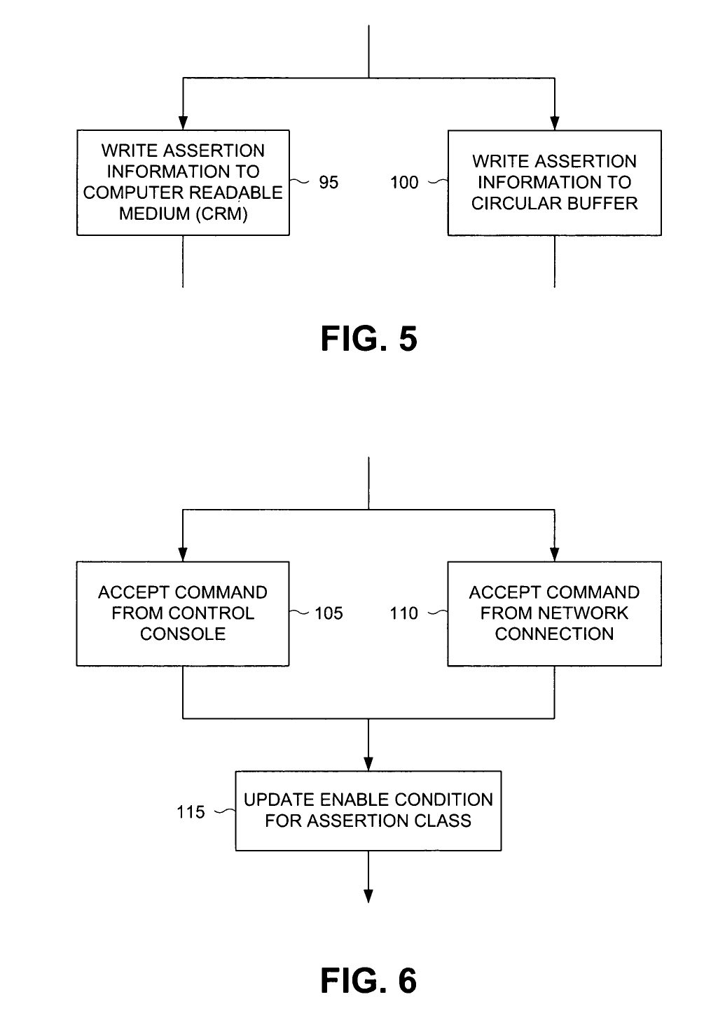

FIG. 5 is a flow diagram that depicts two illustrative example methods for recording an assertion. According to one variation of the present method, information regarding an assertion violation is written to a computer readable medium (CRM) (step 95). Examples of such computer readable medium include, but are not limited to, random access memory, read-only memory (ROM), Compact Disk (CD) ROM, floppy disks and magnetic tape. Once written, this information can be retrieved at a later time, e.g. by using either a standard or custom computer program. For example, one alternative variation of the method may write assertion information to a file that is compatible with a commercially available database program. In this case, the commercial database program could be used to access the information, format the information into a report and then print the report. The printed report could then be used by a computer programmer as an aid in identifying design flaws in a computer program.

According to another variation of the present method, information regarding an assertion violation is written to a circular buffer (step 100). Typically, the circular buffer is a particular sized area in computer memory reserved for recording assertion violation information. When the circular buffer becomes full of assertion information, new assertion information overwrites the oldest assertion information, in a circular manner. Use of a circular buffer ensures that assertion data never occupy more than the particular memory size allocated to the circular buffer. According to yet another alternative variation of the present method, assertion violation data is transferred from the circular buffer to computer readable medium when the circular buffer can no longer reliably accept additional information without overrunning its capacity. This transfer need not be done after every assertion violation, but only often enough so that the circular buffer is not overwritten. By applying this alternative method, fewer processing resources are expended compared to accessing computer readable medium after every assertion violation.

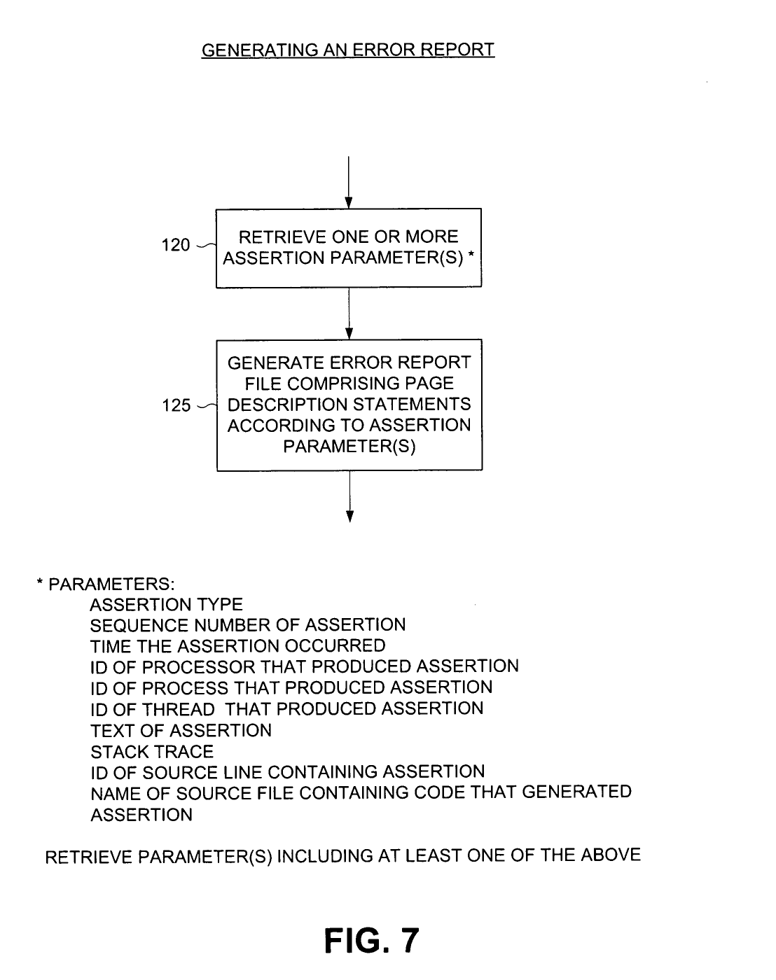

FIG. 6 is a flow diagram that depicts a method for specifying enablement of assertions. According to this method, a command is accepted from a control console (step 105) or from a network connection (step 110). An enable condition is updated according to the received command (step 115). According to this example method, the condition includes, but is not limited to at least one of a condition for each type of assertion, a condition for each program component and a condition for each type of assertion for each program component. One example variation of the present method comprises updating enable conditions stored in a table (for example, as that represented in FIG. 3). The updated enable condition, according to one alternative method, takes effect in an executing program without requiring that the executing program be halted and restarted and without requiring that the source code of the executing program be recompiled. This ability allows a programmer, for example, to change the criteria for accepting assertions while the program being tested is still executing. This capability is very useful when debugging an operating system, or other continuously running software.

FIG. 1 also depicts another example variation of the present method for making available assertion violation information. According to this alternative method, monitoring computer software further comprises generating an error report according to a recorded assertion (step 20). According to yet another variation of the present method, monitoring computer software further comprises dispatching an error report to a real-time assertion monitor (step 25). A real-time assertion monitor, for example, comprises a process for storing or displaying information pertaining to assertion violations, wherein this process can be executed either locally on a computer that is executing the program that sourced an assertion request (i.e. a target computer) or it can be executed on a different computer. The real-time assertion monitor, according to one alternative embodiment, comprises a substantially real-time display of assertion violation activity exhibited by a monitored program executing on the target computer.

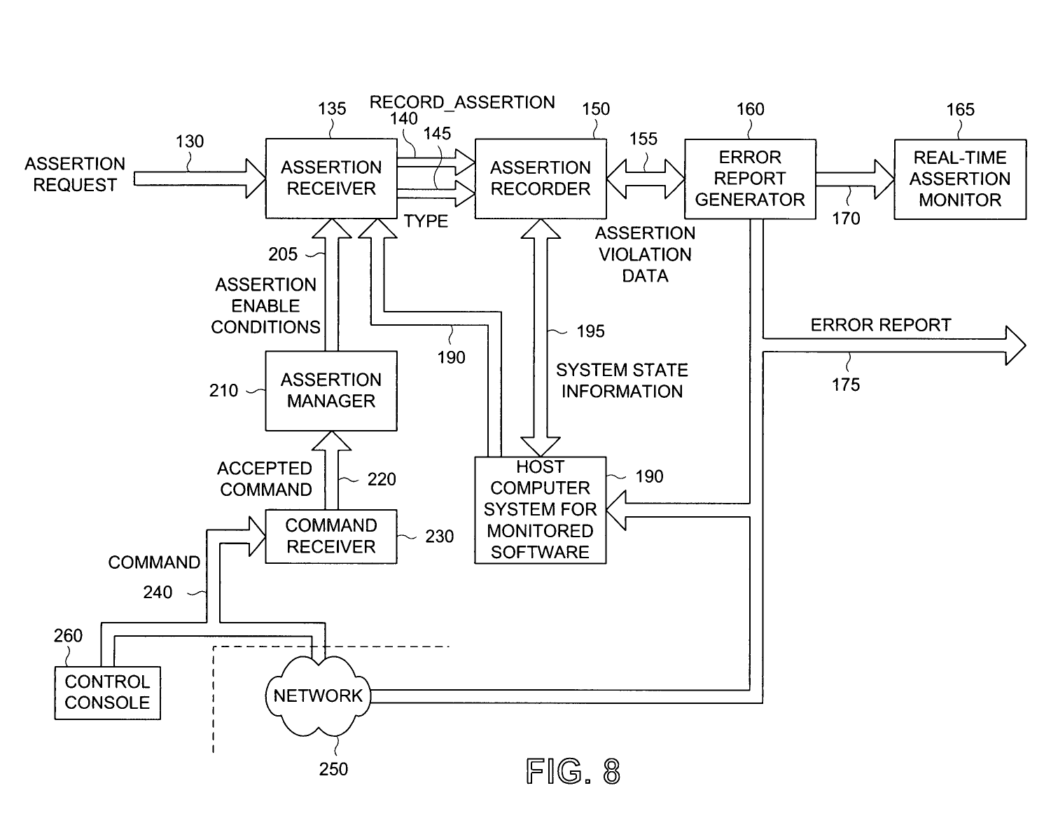

FIG. 7 is a flow diagram that depicts one illustrative alternative example embodiment of a method, for generating an error report. According to this illustrative alternative example method, an assertion violation parameter is retrieved (step 120), e.g. from a computer readable medium, or wherever the parameter data have been recorded or otherwise stored. This parameter data includes, but is not limited to at least one of an assertion type, a sequence number, a time at which the assertion occurred, identification of a processor that produced the assertion, identification of a process that produced the assertion, identification of a thread that produced the assertion, text associated with the assertion, a stack trace, a source line containing the assertion, and a file name of the source containing the code that generated the assertion. A report file is generated comprising page description statements according to the retrieved assertion violation parameter (step 125). One alternative example method provides for generating page description statements in a mark-up language compatible with a web browser, for example, such languages include but are not limited to hyper-text markup language (HTML). To generate the report, it is not necessary that data for only one recorded assertion parameter at a time be retrieved and added to the report file. According to a variation of the present method, a block of parameter data comprising more than one recorded assertions is retrieved and added to the report file.

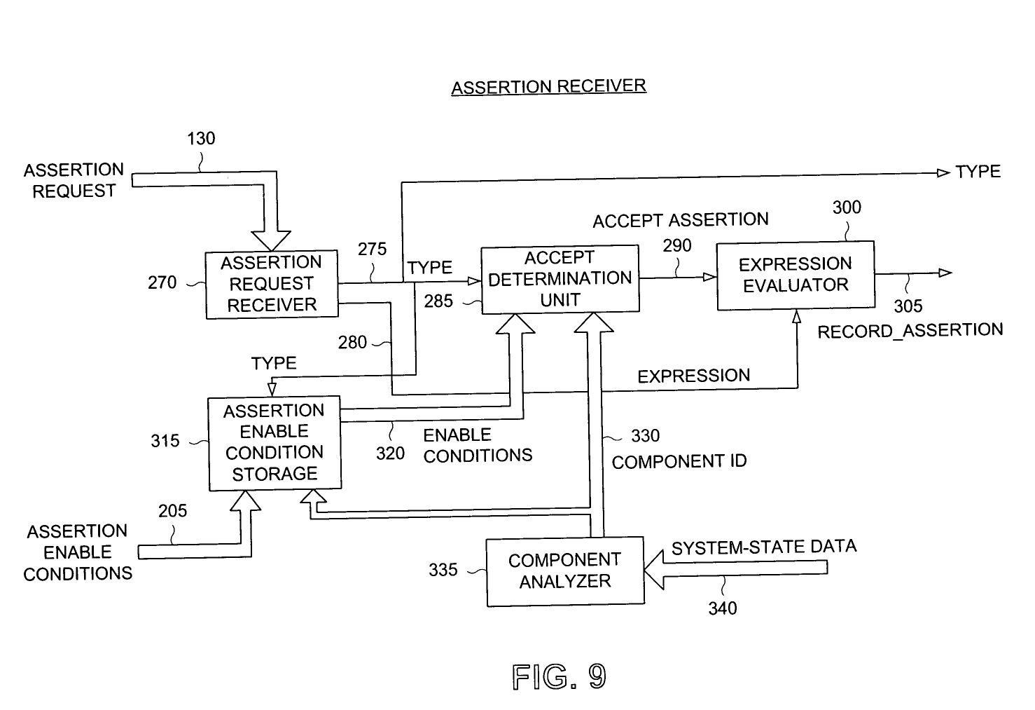

FIG. 8 is a block diagram that depicts one illustrative embodiment of a software monitor. According to this embodiment, a software monitor comprises an assertion receiver 135 and an assertion recorder 150. The assertion receiver 135 receives an assertion request 130 from an executing process included in the software that is being monitored. According to one example embodiment, the assertion request 130 comprises an assertion type and an assertion expression. When the assertion receiver 135 determines that the assertion is to be recorded, it asserts a RECORD_ASSERTION signal 140. According to one alternative example embodiment, the assertion receiver 135 additionally outputs a TYPE signal 145 that is indicative of a type for the assertion. When the assertion recorder 150 detects the RECORD_ASSERTION signal 140, it records assertion violation data.

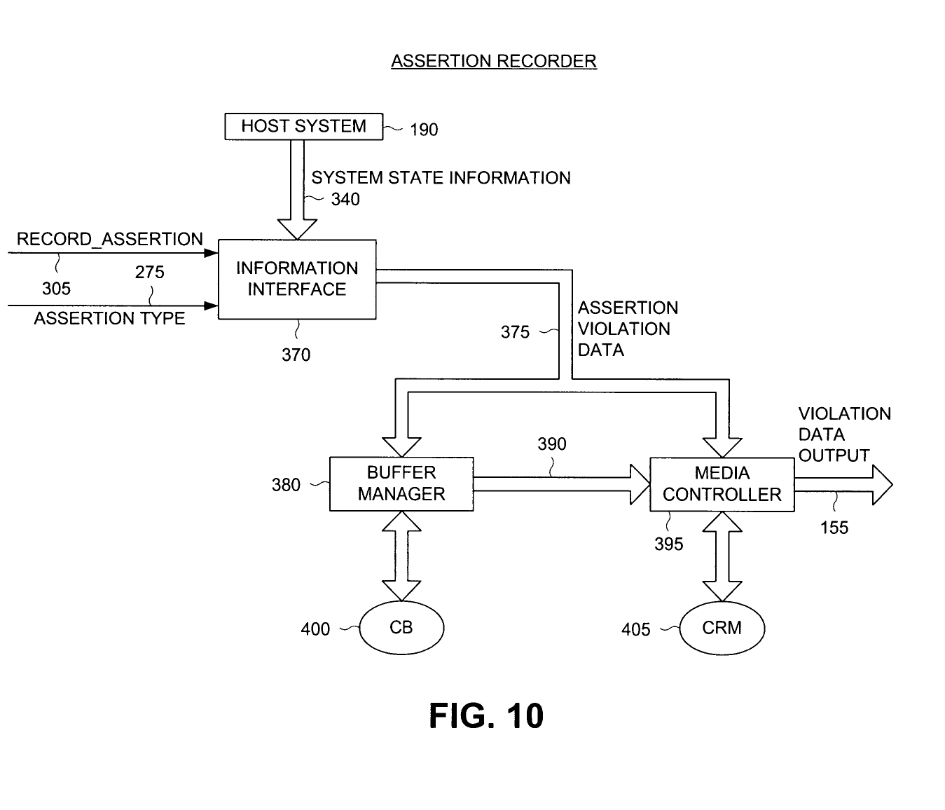

FIG. 9 is a block diagram that depicts one illustrative alternative embodiment of an assertion receiver. According to this alternative embodiment, an assertion receiver 135 comprises an assertion request receiver 270, an accept determination unit 285 and an expression evaluator 300. The assertion request receiver 270, according to yet another illustrative embodiment, receives an assertion request 130 and extracts sufficient information from the assertion request 130 so as to enable generation of a TYPE signal 275. The TYPE signal 275 is indicative of a type for the incoming assertion request 130. The assertion request receiver 270 extracts further information from the incoming assertion request 130 so as to enable generation of an EXPRESSION signal 280 that is associated with the assertion request 130. The EXPRESSION signal 280 carries a representation of an expression associated with an incoming assertion request 130. According to one alternative embodiment, the accept determination unit 285 recognizes the type of an incoming assertion request 130 represented by the TYPE signal 275 and generates an ACCEPT ASSERTION signal 290 when the recognized assertion type is enabled.

According to one alternative embodiment, an assertion receiver 135 further comprises an assertion enable condition storage unit 315 that is used to store information pertaining to presently active enable conditions of each of one or more different possible assertion types. The accept determination unit 285 retrieves from the enable condition storage unit 315 an enable condition 320 for an incoming assertion request 130 according to the TYPE signal 275. The accept determination unit 285 generates an ACCEPT ASSERTION signal 290 when the recognized assertion type is enabled. The accept determination unit 285 returns execution to the executing program that generated the assertion request when the recognized assertion type is not enabled. The expression evaluator 300 evaluates an assertion expression carried by the EXPRESSION signal 280 when it detects the ACCEPT ASSERTION signal 290. When the expression evaluates to FALSE, the expression evaluator 300 generates a RECORD_ASSERTION signal 305 and returns execution to the executing program that generated the assertion request. When the expression evaluates to TRUE, the expression evaluator 300 returns execution to the executing program that generated the assertion request 130.

FIG. 9 depicts yet another illustrative alternative embodiment wherein an assertion receiver 135 further comprises a component analyzer 335. The component analyzer 335 determines which component of a monitored executing program generated an assertion request 130. According to this embodiment, the component analyzer 335 receives system state data 340. The component analyzer 335 maps this received system state data 340 to a component identification and generates a COMPONENT ID signal 330. According to one alternative embodiment, the assertion receiver 135 further comprises an assertion enable condition storage unit 315 capable of storing presently active enable conditions for one or more components of a monitored executing program. A particular enable condition entry stored in the assertion enable condition storage unit 315 is selected by the COMPONENT ID signal 330 generated by the component analyzer 335 and is used by the accept determination unit 285 as one factor in asserting the ACCEPT ASSERTION signal 290.

The accept determination unit 285 generates an ACCEPT ASSERTION signal 290 when the enable condition 320 for a particular assertion-sourcing component of a monitored program is enabled. The accept determination unit 285 returns execution to the executing program that generated the assertion request when the enable condition 320 for that component is not enabled. According to this illustrative alternative embodiment, the assertion request receiver 270 generates an EXPRESSION signal 280 according to an expression included in a received assertion request 130. The expression evaluator 300 evaluates the assertion expression carried by the EXPRESSION signal 280 when it detects the ACCEPT ASSERTION signal 290. When the expression evaluates to FALSE, the expression evaluator 300 generates a RECORD_ASSERTION signal 305 and returns execution to the executing program that generated the assertion request. When the expression evaluates to TRUE, the expression evaluator 300 returns execution to the executing program that generated the assertion.

FIG. 9 further depicts yet another illustrative alternative embodiment of an assertion receiver. According to this illustrative alternative embodiment, the accept determination unit 285 recognizes an assertion type represented by the TYPE signal 275 and generates an ACCEPT ASSERTION signal 290 when a component that generated the assertion request has the recognized assertion type enabled. The assertion receiver 135 of this alternative embodiment further comprises an assertion enable condition storage unit 315 that contains a table (cf. as presented in FIG. 3) for storing presently active enable conditions for each of one or more assertion types for each of one or more components of a monitored executing program. The accept determination unit 285 retrieves from the enable condition storage unit 315 an enable condition 320 according to a recognized assertion type (e.g. by means of the TYPE signal 275) and according to a determined program component (.g. by means of the COMPONENT ID signal 330) that sourced an assertion request. The accept determination unit 285 generates an ACCEPT ASSERTION signal 290 when an assertion type for a particular component is enabled. The accept determination unit 285 returns execution to the executing program that generated the assertion request when the combination of recognized assertion type and component is not enabled.

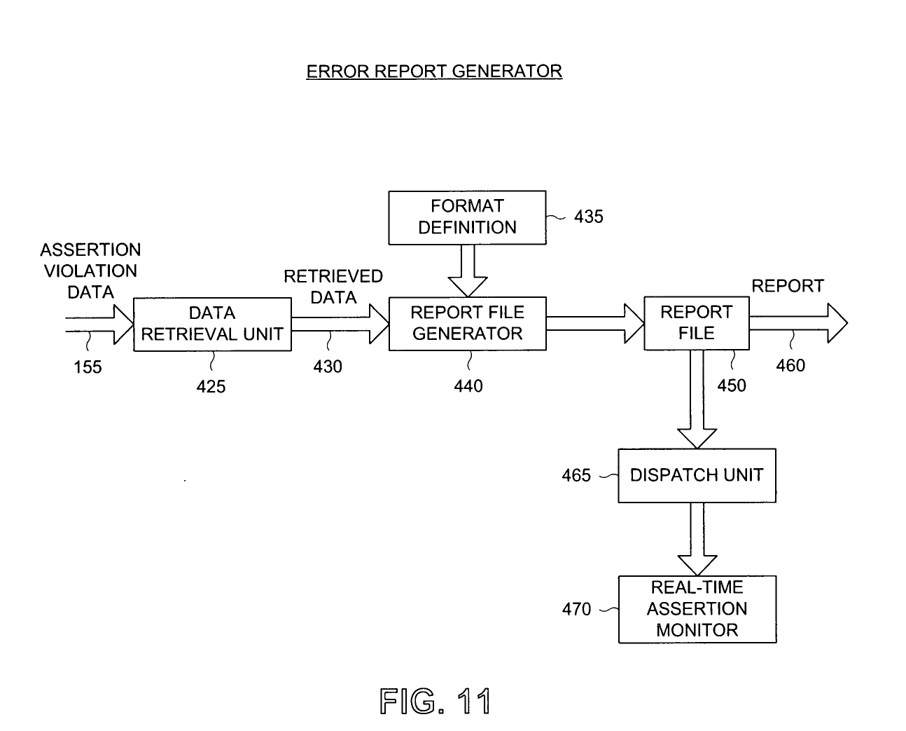

FIG. 10 is a block diagram that depicts one illustrative alternative embodiment of an assertion recorder. According to this alternative embodiment, an assertion recorder 150 includes an information interface 370. The information interface 370 receives system state information 340 including, but not limited to at least one of an assertion type, a sequence number, a time at which an assertion occurred, an identification of a processor that produced the assertion, an identification of a process that produced the assertion, an identification of a thread that produced the assertion, text associated with the assertion, a stack trace, a source line containing the assertion and a file name of a source program component containing the code that generated the assertion. According to one alternative example embodiment, the information interface 370 also receives a TYPE signal 275 representing the type of an assertion. Recording of assertion information occurs when the information interface 370 perceives an active RECORD ASSERTION signal 305. It should be noted that according to one alternative embodiment, the RECORD ASSERTION signal 305 is generated by an expression evaluator 300 included in an assertion receiver 135.

According to one alternative embodiment, the assertion recorder 150 further comprises a media controller 395. According to this alternative embodiment, the information interface 370 receives system state information 340 pertaining to an assertion and directs this assertion pertinent information to the media controller 395. The information interface 370 also directs a rendition of the TYPE signal 275 to the media controller 395. This assertion pertinent information is also referred to as assertion violation data 375 and can be augmented with information pertaining to the type of an assertion. The media controller 395 conveys the assertion violation data 375 to a computer readable medium (CRM) 405. The computer readable medium 405 includes, but is not limited to random access memory, read-only memory (ROM), CD ROM, floppy disks, and magnetic tape. The media controller 395 also is capable retrieving recorded assertion violation data 155 from the computer readable media 405. Such recorded assertion violation data 155 may be used by a subsequent process, e.g. an error report generator 160.

According to yet another illustrative alternative embodiment, an assertion recorder 150 further comprises a buffer manager 380. The buffer manager 380 conveys assertion violation data 375 received from the information interface 370 to a circular buffer (CB) 400. According to a variation of this example embodiment, an assertion recorder 150 further comprises a media controller 395 as described supra. According to this example embodiment, the buffer manager 380 transfers assertion violation data from the circular buffer 400 to the media controller 395 using a memory transfer interface 390. This transfer occurs when the circular buffer 400 is likely to overrun, e.g. when its available storage capacity falls below a pre-established threshold.

FIG. 8 also illustrates that a software monitor, according to one alternative embodiment, further comprises a command receiver 230 and an assertion manager 210. The command receiver 230 accepts a command 240 from at least one of a control console 260 and a network connection 250. The assertion manager 210 updates an enable condition 205 for an assertion class according to an accepted command 220. The assertion class includes at least one of a type of an assertion and a component in a monitored software program that is capable of sourcing an assertion. According to one alternative embodiment, the assertion manager 210 stores an assertion enable condition 205 in a table maintained in an assertion enable condition storage unit 315 included in an assertion receiver 135.

FIG. 8 further illustrates that one alternative embodiment of a software monitor further comprises an error report generator. The error report generator 160 generates an error report 175 according to assertion violation data 155 recorded by the assertion recorder 150. The error report 175 can be delivered to a process executing on a host system 190 or to a process executing on a different system. The receiving process may be a print driver or a display driver. According to one alternative embodiment, the error report 175 is conveyed to a different system using a computer network 250. It should be noted that the claims appended hereto are not intended to be limited to any particular means for conveying an error report to another computer system. Any suitable communications interface may be used for such conveyance of the error report.

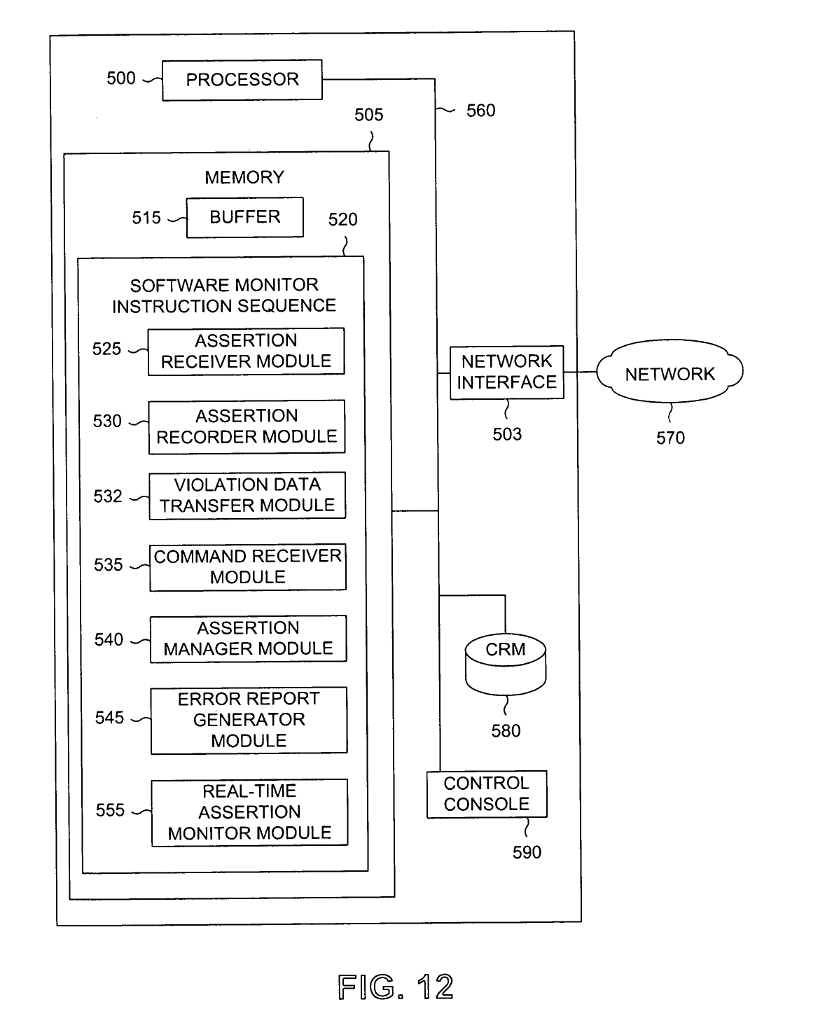

FIG. 11 is a block diagram that depicts one illustrative embodiment of an error report generator. According to this illustrative embodiment, an error report generator 160 comprises a data retrieval unit 425 that is capable of retrieving assertion violation data 155. Said assertion violation data 155 includes, but is not necessarily limited to at least one of an assertion type, a sequence number, a time at which the assertion occurred, an identification of a processor that produced the assertion, an identification of a process that produced the assertion, an identification of a thread that produced the assertion, text associated with the assertion, a stack trace, a source line containing the assertion and a file name of containing source code of a component that generated the assertion.

This illustrative embodiment further comprises a report file generator 440. The report file generator 440 generates a report file 450 based on the retrieved assertion violation data 430. According to one alternative embodiment, the report file generator 440 creates a file that includes one or more page description statements conforming to a page description language (e.g. HTML). According to one alternative embodiment, the report file generator 440 uses a format definition 435 included in the error report generator 440 as a basis for organizing any page description statements included in the error report file 450 it generates. One alternative embodiment of an error report generator 160 further comprises a dispatch unit 465 that dispatches an error report file 450 to a real-time assertion monitor 470.

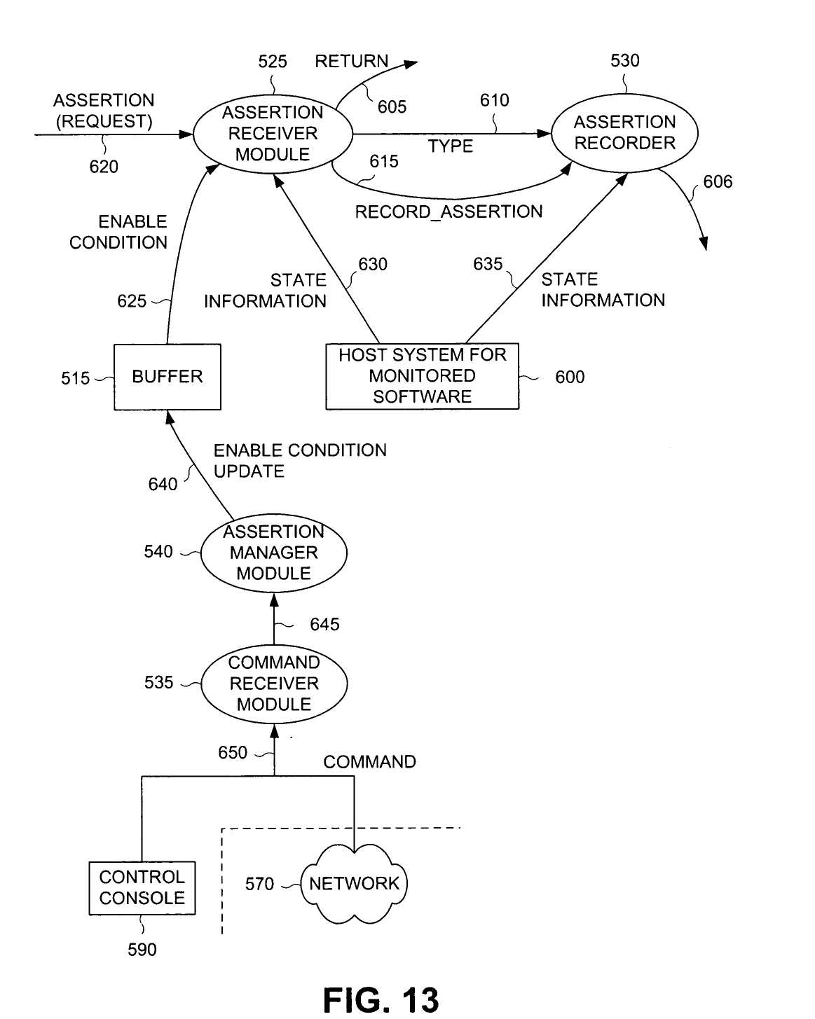

FIG. 12 is a block diagram that depicts one alternative example embodiment of a software monitor. According to this alternative example embodiment, a software monitor comprises one or more processors 500 and a memory 505. These elements are connected by one or more internal data buses 560. According to one alternative embodiment, a portion of the memory 505 is set aside as a buffer 515, which is used to store information according to the teaching described infra. This alternative example embodiment further comprises a software monitor instruction sequence 520 that itself comprises various functional modules each of which comprises an instruction sequence. For purposes of this disclosure, a functional module and its corresponding instruction sequence is referred to by a process name. The instruction sequence that implements the process name, according to one alternative embodiment, is stored in the memory 505. The reader is advised that the term “minimally causes the processor” and variants thereof is intended to serve as an open-ended enumeration of functions performed by the processor as it executes a particular functional process (i.e. instruction sequence). As such, an embodiment where a particular functional process causes the processor to perform functions in addition to those defined in the appended claims is to be included in the scope of the claims appended hereto.

According to one example embodiment of a software monitor, instruction sequences that implement functional modules are stored in the memory 505 including an assertion receiver module 525 and an assertion recorder module 530. According to one alternative embodiment, two additional instruction sequences that implement a command receiver module 535 and that implement an assertion manager module 540, respectively, are also included in the memory 505. According to another alternative embodiment, an additional instruction sequence that implements an error report generator module 545 is also included in the memory 505. In yet another alternative embodiment, an additional instruction sequence that implements a real-time assertion monitor module 555 is also included in the memory 505. In yet another alternative embodiment, an additional instruction sequence that implements a violation data transfer module 532 is also included in the memory 505.

According to one example embodiment, the software monitor further comprises a control console 590. The processor 500 is capable of reading data from and writing data to the control console 590 via the internal data bus 560. According to another example embodiment, the software monitor further comprises a connection to a network 570. The processor 500 is capable of reading data from and writing data to the network 570 via a network interface 503. The network interface 503 is included in one alternative embodiment and is connected to the internal data bus 560. According to yet another example embodiment, the software monitor further comprises a computer readable medium (CRM) 580. The processor 500 is capable of reading data from and writing data to the computer readable medium 580 via the internal data bus 560.

The functional processes (and their corresponding instruction sequences) described thus far that enable monitoring of software are, according to one alternative embodiment, imparted onto computer readable medium. Examples of such medium include, but are not limited to, random access memory, read-only memory (ROM), CD ROM, floppy disks, and magnetic tape. This computer readable medium, which alone or in combination can constitute a stand-alone product, can be used to convert a general-purpose computing platform into a device for monitoring software according to the techniques and teachings presented herein.

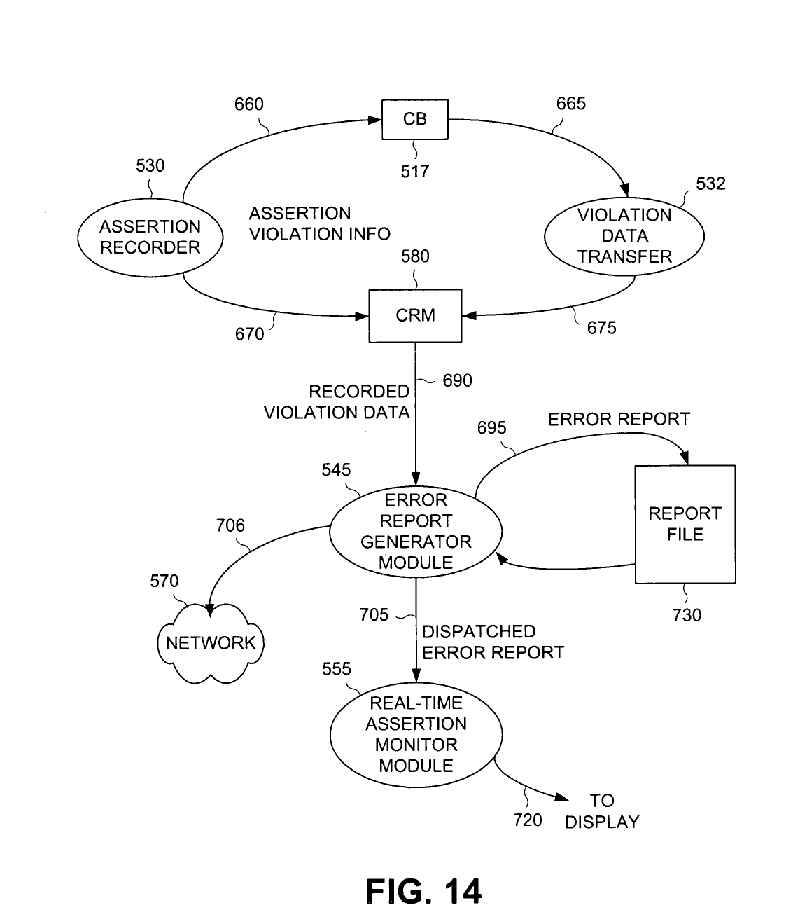

FIGS. 13 and 14 collectively comprise a data flow diagram that depicts the operation of one illustrative embodiment of a software monitor. According to this illustrative embodiment, the software monitor instruction sequence 520 is executed by the processor 500. When executed by the processor 500, the software monitor instruction sequence 520 minimally causes the processor 500 to receive an assertion 620 from an executing process, to record the assertion, and to allow the executing process that sourced the assertion 620 to continue execution.

According to one alternative embodiment, the software monitor instruction sequence 520 includes an assertion receiver module 525 that, when executed by the processor 500, minimally causes the processor 500 to receive an assertion request 620, determine a type for the assertion request and accept the assertion request when the determined type of assertion is enabled. In order to accomplish this, according to one alternative embodiment, the assertion receiver module 525 minimally causes the processor 500 to extract type information from the assertion request 620. The type of the assertion is used to consult a table of assertion enablement conditions 625 according to assertion type. According to one example embodiment, such a table is stored in the buffer 515.

According to one alternative embodiment, the software monitor instruction sequence 520 includes an assertion receiver module 525 that, when executed by the processor 500, minimally causes the processor 500 to receive an assertion request 620, determine what component sourced the assertion request and accept the assertion request when the determined component has assertion requests enabled. In order to accomplish this, according to one alternative embodiment, the assertion receiver module 525 minimally causes the processor 500 to determine a sourcing component for the assertion request according to system state information 630 received from a host system 600 that is executing the software that is being monitored. The sourcing component of the assertion is used to consult a table of assertion enablement conditions 625 according to source component. Such a table, according to one alternative embodiment, is stored in the buffer 515.

According to one alternative embodiment, the software monitor instruction sequence 520 includes an assertion receiver module 525 that, when executed by the processor 500, minimally causes the processor 500 to receive an assertion request 620, determine what component sourced the assertion request and determine a type for the incoming assertion request 620. According to this alternative embodiment, the assertion receiver module 525 minimally causes the processor to accept the assertion request 620 when the determined component has assertion requests for the determined type enabled. In order to accomplish this, according to one alternative embodiment, the assertion receiver module 525 minimally causes the processor 500 to extract assertion type information from the assertion request 620 and to determine a sourcing component for the assertion request according to system state information 630 received from a host system 600 that is executing the software that is being monitored. The sourcing component of the assertion and the type of the assertion is used to consult a table of assertion enablement conditions 625 according to source component and assertion type. Said table, according to one alternative embodiment is stored in the buffer 515.

Once the assertion receiver module 525 accepts an assertion request 620, one alternative embodiment minimally causes the processor 500 to dispatch a RECORD_ASSERTION message 615 when an expression associated with an incoming assertion request 620 evaluates to FALSE. Execution is returned 605 to the executing process that generated the assertion request 620 when the expression evaluates to TRUE. According to one alternative embodiment, the expression associated with an assertion is included in the assertion request 620.

According to one example embodiment, the software monitor instruction sequence 520 includes an assertion recorder module 530. When executed by the processor 500, the assertion recorder module 530 minimally causes the processor 500 to record at least one assertion violation datum including, but not limited to at least one of an assertion type, a sequence number, a time at which the assertion occurred, an identification of a processor that produced the assertion, an identification of a process that produced the assertion, an identification of a thread that produced the assertion, text associated with the assertion, a stack trace, a source line containing the assertion, and a file name of the source containing the code that generated the assertion. This assertion violation datum is determined from system state information 635 received by the processor 500 as it executes the assertion recorder module 530. Once recording is accomplished, execution is returned 606 to the executing process that sourced the assertion request.

FIG. 14 illustrates that, according to one alternative embodiment, the assertion recorder module 530, when executed by the processor 500, minimally causes the processor 500 to write assertion violation information 670 to a computer readable medium (CRM) 580. In yet another example embodiment, when executed by the processor 500, the assertion recorder module 530 minimally causes the processor 500 to write assertion violation information 660 to a circular buffer (CB) 517.

According to yet another example embodiment, the software monitor instruction sequence 520 further comprises a violation data transfer module 532. The violation data transfer module 532 transfers assertion violation data 665 from the circular buffer 517 to the computer readable medium 580 on an as-needed basis—e.g. when the circular buffer becomes filled with a pre-established quantity of assertion violation data.

FIG. 13 further depicts that, according to one alternative embodiment, the software monitor further comprises a command receiver module 535 and an assertion manager module 540. When executed by the processor 500, the command receiver module 535 minimally causes the processor 500 to accept a control class enable control command 650 from at least one the control console 590 and the network 570 via a network connection. When executed by the processor 500, the assertion manager module 540 further minimally causes the processor 500 to update an enable condition 640 stored in the buffer 515. According to one alternative example embodiment, the assertion manager module 540 maintains in the buffer 515 a table of enablement flags according to at least one of a type of assertion and a source component as heretofore described.

FIG. 14 illustrates that, according to another example embodiment, a software monitor instruction sequence 520 further comprises an error report generator module 545. When executed by the processor 500, the error report generator module 545 minimally causes the processor 500 to generate an error report 730 according to recorded assertion violation data 690 stored in the computer readable medium 580. According to one alternative embodiment, the error report generator module 545, when executed by the processor 500, minimally causes the processor 500 to dispatch 705 the error report 730 to a real-time assertion monitor module 555. According to one alternative embodiment, the real-time assertion monitor module 555 directs its output to a display 720 (e.g. to a display driver capable of converting its received input to a signal that can be displayed on a display device). In yet another alternative embodiment, the error report generator module 545 minimally causes the processor 500 to dispatch 706 the error report 730 over a network 570.

According to another alternative embodiment, the error report generator module 545, when executed by the processor 500, minimally causes the processor 500 to receive from the computer readable medium 580 an assertion violation datum. Retrieval of an assertion violation data includes, but is not limited to retrieval of at least one of an assertion type, a sequence number, a time at which the assertion occurred, identification of a processor that produced the assertion, identification of a process that produced the assertion, identification of a thread that produced the assertion, text associated with the assertion, a stack trace, a source line containing the assertion and file name of the source containing the code that generated the assertion. Additionally, when executed by the processor 500, the error report generator module 545 minimally causes the processor 500 to generate data for a report file 730 comprising page description statements according to the assertion violation datum. These page description statements, according to one alternative embodiment, conform to a page description language compatible with a web browser—e.g. HTML. It should be noted that the scope of the appended claims is not intended to be limited only to HTML page description languages.

While the present method, apparatus and software have been described in terms of several alternative methods and exemplary embodiments, it is contemplated that alternatives, modifications, permutations, and equivalents thereof will become apparent to those skilled in the art upon a reading of the specification and study of the drawings. It is therefore intended that the true spirit and scope of the appended claims include all such alternatives, modifications, permutations, and equivalents.

1. A method for monitoring computer software comprising:
receiving an assertion from an executing process;
recording the assertion when it is violated; and
allowing the executing process to continue execution.

2. The method of claim 1 wherein receiving an assertion comprises:
receiving an assertion request;
recognizing a type for the assertion request; and
accepting the assertion request when the determined type is enabled.

3. The method of claim 1 wherein receiving an assertion comprises:
receiving an assertion request;
determining a component that sourced the assertion request; and
accepting the assertion request when the determined component has assertion requests enabled.

4. The method of claim 1 wherein recording the assertion comprises recording a datum that includes at least one of:
type of assertion,
sequence number of the assertion,
time at which the assertion occurred,
identification of processor that produced the assertion,
identification of process that produced the assertion,
identification of the thread that produced the assertion,
text of the assertion,
stack trace,
source line containing the assertion, and
file name of the source containing the code that generated the assertion.

5. The method of claim 1 wherein recording the assertion comprises writing information regarding the assertion violation to a computer readable medium.

6. The method of claim 1 wherein recording the assertion comprises writing information regarding the assertion violation to a circular buffer.

7. The method of claim 1 further comprising:
accepting a command from at least one of a control console and a network connection; and
updating an enable condition for an assertion class according to the command.

8. The method of claim 1 further comprising generating an error report according to the recorded assertion.

9. The method of claim 8 further comprising dispatching the error report to a real-time assertion monitor.

10. The method of claim 8 wherein generating an error report comprises:
retrieving an assertion violation parameter including at least one of:
type of assertion,
sequence number of the assertion,
time at which the assertion occurred,
identification of processor that produced the assertion,
identification of process that produced the assertion,
identification of the thread that produced the assertion,
text of the assertion,
stack trace,
source line containing the assertion, and
file name of the source containing the code that generated the assertion; and
generating a report file comprising page description statements according to the assertion parameter.

11. An apparatus for monitoring computer software comprising:
assertion receiver that receives an assertion from an executing process; and
assertion recorder that records the assertion when it is violated.

12. The apparatus of claim 11 wherein the assertion receiver comprises:
assertion request receiver that receives an assertion request; and
assertion accept determination unit that recognizes an assertion type and generates an accept assertion signal when the recognized assertion type is enabled.

13. The apparatus of claim 11 wherein the assertion receiver comprises:
assertion request receiver that receives an assertion request;
assertion component analyzer that determines a component that generated the assertion request;
assertion accept determination unit that generates an accept assertion signal when the component that generated the assertion request has assertions enabled.

14. The apparatus of claim 11 wherein the assertion recorder is capable of recording a datum that includes at least one of:
type of assertion,
sequence number of the assertion,
time at which the assertion occurred,
identification of processor that produced the assertion,
identification of process that produced the assertion,
identification of the thread that produced the assertion,
text of the assertion,
stack trace,
source line containing the assertion, and
file name of the source containing the code that generated the assertion.

15. The apparatus of claim 11 wherein the assertion recorder comprises:
information interface that receives assertion violation data; and
media controller that conveys the assertion violation data to a computer readable medium.

16. The apparatus of claim 11 wherein the assertion recorder comprises:
information interface that receives assertion violation data; and
buffer manager that conveys the assertion violation data to a circular buffer.

17. The apparatus of claim 11 further comprising:
command receiver capable of accepting a command from at least one of a control console and a network connection; and
assertion manager capable of updating an enable condition for an assertion class according to the command.

18. The apparatus of claim 11 further comprising an error report generator capable of generating an error report according to the recorded assertion.

19. The apparatus of claim 18 further comprising a dispatch unit capable of dispatching an error report to a real-time assertion monitor.

20. The apparatus of claim 18 wherein the error report generator comprises:
data retrieval unit that retrieves an assertion violation parameter including at least one of:
type of assertion,
sequence number of the assertion,
time at which the assertion occurred,
identification of processor that produced the assertion,
identification of process that produced the assertion,
identification of the thread that produced the assertion,
text of the assertion,
stack trace,
source line containing the assertion, and
file name of the source containing the code that generated the assertion; and
report file generator capable of generating a report file comprising page description statements according to the assertion parameter.

21. A computer software monitoring system comprising:
memory capable of storing instructions;
processor capable of executing instructions stored in the memory; and
software monitor instruction sequence that, when executed by the processor, minimally causes the processor to:
receive an assertion from an executing process,
record the assertion, and
allow the executing process to continue execution.

22. The computer software monitoring system of claim 21 wherein the software monitor instruction sequence comprises an assertion receiver instruction sequence that, when executed by the processor, minimally causes the processor to receive an assertion by minimally causing the processor to:
receive an assertion request;
recognize a type for the assertion request; and
accept the assertion request when the determined type is enabled.

23. The computer software monitoring system of claim 21 wherein the software monitor instruction sequence comprises an assertion receiver instruction sequence that, when executed by the processor, minimally causes the processor to receive an assertion by minimally causing the processor to:
receive an assertion request;
determine a component that sourced the assertion request; and
accept the assertion request when the determined component has assertion requests enabled.

24. The computer software monitoring system of claim 21 wherein the software monitor instruction sequence comprises an assertion recorder instruction sequence that, when executed by the processor, minimally causes the processor to record an assertion by minimally causing the processor to record a datum that includes at least one of:
type of assertion,
sequence number of the assertion,
time at which the assertion occurred,
identification of processor that produced the assertion,
identification of process that produced the assertion,
identification of the thread that produced the assertion,
text of the assertion,
stack trace,
source line containing the assertion, and
file name of the source containing the code that generated the assertion.

25. The computer software monitoring system of claim 21 wherein the software monitor instruction sequence comprises an assertion recorder instruction sequence that, when executed by the processor, minimally causes the processor to record an assertion by minimally causing the processor to write information regarding the assertion to a computer readable medium.

26. The computer software monitoring system of claim 21 wherein the software monitor instruction sequence comprises an assertion recorder instruction sequence that, when executed by the processor, minimally causes the processor to record an assertion by minimally causing the processor to write information regarding the assertion to a circular buffer.

27. The computer software monitoring system of claim 21 wherein the software monitor instruction sequence further minimally causes the processor to:
accept a command from at least one of a control console and a network connection; and
update an enable condition for an assertion class according to the command.

28. The computer software monitoring system of claim 21 wherein the software monitor instruction sequence further minimally causes the processor to generate an error report according to the recorded assertion.

29. The computer software monitoring system of claim 28 wherein the software monitor instruction sequence further minimally causes the processor to dispatch the error report to a real-time assertion monitor.

30. The computer software monitoring system of claim 28 wherein the software monitor instruction sequence comprises an error report generator instruction sequence that, when executed by the processor, minimally causes the processor to generate an error report by minimally causing the processor to:
retrieve an assertion violation parameter including at least one of:
type of assertion,
sequence number of the assertion,
time at which the assertion occurred,
identification of processor that produced the assertion,
identification of process that produced the assertion,
identification of the thread that produced the assertion,
text of the assertion,
stack trace,
source line containing the assertion, and
file name of the source containing the code that generated the assertion; and
generate a report file comprising page description statements according to the assertion parameter.

31. A computer-readable medium having computer-executable instructions for performing a method for monitoring computer software, the instructions comprising modules for:
receiving an assertion from an executing process;
recording the assertion; and
allowing the executing process to continue execution.

32. The computer-readable medium of claim 31 wherein the receiving an assertion module comprises modules for:
receiving an assertion request;
recognizing a type for the assertion request; and
accepting the assertion request when the determined type is enabled.

33. The computer-readable medium of claim 31 wherein the receiving an assertion module comprises modules for:
receiving an assertion request;
determining a component that sourced the assertion request; and
accepting the assertion request when the determined component has assertion requests enabled.

34. The computer-readable medium of claim 31 wherein the recording the assertion module comprises a module for recording a datum that includes at least one of:
type of assertion,
sequence number of the assertion,
time at which the assertion occurred,
identification of processor that produced the assertion,
identification of process that produced the assertion,
identification of the thread that produced the assertion,
text of the assertion,
stack trace,
source line containing the assertion, and
file name of the source containing the code that generated the assertion.

35. The computer-readable medium of claim 31 wherein the recording the assertion module comprises a module for writing information regarding the assertion to a computer readable medium.

36. The computer-readable medium of claim 31 wherein the recording the assertion module comprises a module for writing information regarding the assertion to a circular buffer.

37. The computer-readable medium of claim 31, the instructions further comprising modules for:
accepting a command from at least one of a control console and a network connection; and
updating an enable condition for an assertion class according to the command.

38. The computer-readable medium of claim 31, the instructions further comprising a module for generating an error report according to the recorded assertion.

39. The computer-readable medium of claim 38, the instructions further comprising a module for dispatching the error report to a real-time assertion monitor.

40. The computer-readable medium of claim 38 wherein dispatching the error report module comprises modules for:
retrieving an assertion violation parameter including at least one of:
type of assertion,
sequence number of the assertion,
time at which the assertion occurred,
identification of processor that produced the assertion,
identification of process that produced the assertion,
identification of the thread that produced the assertion,
text of the assertion,
stack trace,
source line containing the assertion, and
file name of the source containing the code that generated the assertion; and
generating a report file comprising page description statements according to the assertion parameter.

41. An apparatus for monitoring computer software comprising:
means for detecting an assertion from an executing process;
means for recording information pertaining to the assertion when it is violated; and
means for allowing the executing process to continue execution.

42. The apparatus of claim 41 wherein means for detecting an assertion comprises:
means for ascertaining the type of an assertion request; and
means for ignoring the assertion request when the ascertained type is not enabled.

43. The apparatus of claim 41 wherein means for detecting an assertion comprises:
means for ascertaining a component that sourced an assertion request; and
means for ignoring the assertion request when the ascertained component does not have assertions enabled.
